(19) United States
(12) Patent Application Publication
(10) Pub. No.: US 2026/0267255 A1
(43) Pub. Date: Sep. 10, 2026

(54) IMAGE FORMING APPARATUS

(71) Applicant: CANON KABUSHIKI KAISHA, Tokyo (JP)

(72) Inventors: KATSUICHI ABE, Kanagawa (JP); HIROKI TANAKA, Kanagawa (JP)

(21) Appl. No.: 19/661,498

(22) Filed: Apr. 28, 2026

Related U.S. Application Data
(63) Continuation of application No. PCT/JP2024/037176, filed on Oct. 18, 2024.

(30) Foreign Application Priority Data
Nov. 1, 2023 (JP) 2023-187633

(51) Int. Cl. G03G 15/02; G03G 15/16

(52) U.S. Cl. CPC G03G 15/0266; G03G 15/0233; G03G 15/167

(57) ABSTRACT

An image forming apparatus includes a first charging member configured to charge the surface of the photosensitive drum at a first charging portion, and a second charging member configured to charge the surface of the photosensitive drum at a second charging portion. The first charging portion is formed downstream of a transfer portion and upstream of the second charging portion in a rotation direction of the photosensitive drum. When a potential difference formed between a second surface potential and the second charging voltage is defined as a charging potential difference, the image forming apparatus controls so that the charging potential difference is greater than or equal to a discharge start voltage during an image forming operation, and controls so that the charging potential difference during a non-image forming operation is less than the charging potential difference during the image forming operation.

### CROSS-REFERENCE TO RELATED APPLICATIONS

This application is a Continuation of International Patent Application No. PCT/JP2024/037176, filed Oct. 18, 2024, which claims the benefit of Japanese Patent Application No. 2023-187633, filed Nov. 1, 2023, both of which are hereby incorporated by reference herein in their entirety.

### BACKGROUND

### Field of the Technology

The present disclosure relates to an image forming apparatus configured to use an electrophotographic recording method, such as a laser printer, a copying machine, or a facsimile.

### Description of the Related Art

In a conventional image forming apparatus using an electrophotographic or electrostatic recording method, a charging method is employed in which a voltage is applied to a charging member in contact with an electrophotographic photosensitive member (hereinafter, referred to as “photosensitive drum”) and a surface of the photosensitive drum is charged by discharge, as a charging method for the photosensitive drum.

Specifically, in a case where a voltage greater than or equal to a threshold is applied to the charging member, discharge is generated between the charging member and the photosensitive drum in accordance with Paschen's law, thereby charging the surface of the photosensitive drum.

In this case, if the number of printed sheets increases, toner serving as a developing agent or an external additive may adhere to and contaminate the surface of the photosensitive drum and/or the surface of the charging member. Consequently, the charging potential on the surface of the photosensitive drum may become non-uniform, and a stable image may not be obtained.

A configuration for solving such an issue is described in Patent Laid-Open No. 2023-56470. Patent Laid-Open No. 2023-56470 describes a charging configuration combining a charging method that uses discharge and a charging method that does not use discharge. An injection charging method refers to a method in which a surface of a photosensitive drum is charged by injecting charge directly into the surface of the photosensitive drum from a charging member. However, the injection charging method may cause the charging potential on the surface of the photosensitive drum to become non-uniform. Accordingly, Japanese Patent Laid-Open No. 2023-56470 describes a configuration in which a charging member using the injection charging method is provided upstream and a charging member using a discharge charging method is provided downstream in a rotation direction of a photosensitive drum, thereby causing the charging member provided downstream to uniformly charge a surface of the photosensitive drum.

However, Japanese Patent Laid-Open No. 2023-56470 has the following issue. The discharge charging method may cause an image defect due to a discharge product generated by discharge or deterioration of the surface of the photosensitive drum. The surface of the photosensitive drum on which discharge products have accumulated or that has undergone surface deterioration exhibits reduced resistance, particularly in a high-temperature, high-humidity environment. In this case, the required surface potential of the photosensitive drum for image formation may not be maintained, and it may be difficult for a developing device to develop a desired toner image.

### SUMMARY

The present disclosure is directed to suppressing discharge generated between a photosensitive drum and a charging member.

An image forming apparatus configured to perform an image forming operation to form an image on a transfer material includes:
a photosensitive drum configured to rotate;
a first charging member configured to be brought into contact with a surface of the photosensitive drum to form a first charging portion and charge the surface of the photosensitive drum at the first charging portion in a case where a first charging voltage is applied;
a second charging member configured to charge the surface of the photosensitive drum at a second charging portion facing the surface of the photosensitive drum in a case where a second charging voltage is applied;
an exposure unit configured to form an electrostatic latent image on the surface of the photosensitive drum charged by the first charging member and the second charging member;
a developing member configured to develop the electrostatic latent image with a developing agent to form a developing agent image on the surface of the photosensitive drum at a developing portion facing the surface of the photosensitive drum;
a transfer member configured to transfer the developing agent image to the transfer material at a transfer portion facing the surface of the photosensitive drum;
a first charging voltage applying unit configured to apply the first charging voltage to the first charging member;
a second charging voltage applying unit configured to apply the second charging voltage to the second charging member; and
a control unit configured to control the first charging voltage and the second charging voltage,
wherein the first charging portion is formed downstream of the transfer portion and upstream of the second charging portion in a rotation direction of the photosensitive drum,
wherein a potential difference formed between a first surface potential formed on the surface of the photosensitive drum and the first charging voltage at the first charging portion is defined as a first charging potential difference,
wherein a potential difference formed between a second surface potential formed on the surface of the photosensitive drum and the second charging voltage at the second charging portion is defined as a second charging potential difference,
wherein the control unit performs control so that the second charging potential difference is greater than or equal to a discharge start voltage during the image forming operation, and
wherein the control unit performs control so that in a state where the photosensitive drum is rotated and the first charging voltage is applied, the second charging potential difference during a non-image forming operation different from the image forming operation is less than the second charging potential difference during the image forming operation.

Features of the present disclosure will become apparent from the following description of embodiments with reference to the attached drawings.

### BRIEF DESCRIPTION OF THE DRAWINGS

FIG. 1 is a schematic cross-sectional view illustrating an image forming apparatus according to a first embodiment.

FIG. 2 is a schematic cross-sectional view illustrating an image forming portion according to the first embodiment.

FIG. 3 is a control block diagram according to the first embodiment.

FIG. 4 is a schematic cross-sectional view illustrating a portion including charging portions according to the first embodiment.

FIG. 5 is a schematic view illustrating a layer configuration of a photosensitive drum according to the first embodiment.

FIG. 6 is a diagram illustrating a charging characteristic of a charging roller according to the first embodiment.

FIG. 7 is a diagram illustrating a charging characteristic of a charging brush according to the first embodiment.

FIG. 8 is a diagram illustrating non-uniformity of the surface potential of the photosensitive drum according to the first embodiment.

FIG. 9 is a timing chart illustrating charging voltage control according to the first embodiment.

FIG. 10 is a timing chart illustrating charging voltage control according to Comparative Example 1.

FIG. 11 is a schematic cross-sectional view illustrating a portion including charging portions according to the second embodiment.

FIG. 12 is a timing chart illustrating charging voltage control according to the second embodiment.

### DESCRIPTION OF THE EMBODIMENTS

Embodiments of the present disclosure will be described in detail with reference to the drawings. It may be understood that the dimensions, materials, shapes, relative arrangements, and the like of the components described in the embodiments may be modified as appropriate depending on the configuration of the apparatus to which the disclosure is applied and various conditions. In other words, the following embodiments are not intended to limit the scope of the present disclosure. It may be noted that, for convenience, unless otherwise specified, voltages or potentials of greater or less (higher or lower) magnitudes are based on comparisons of their absolute values.

### [Image Forming Apparatus]

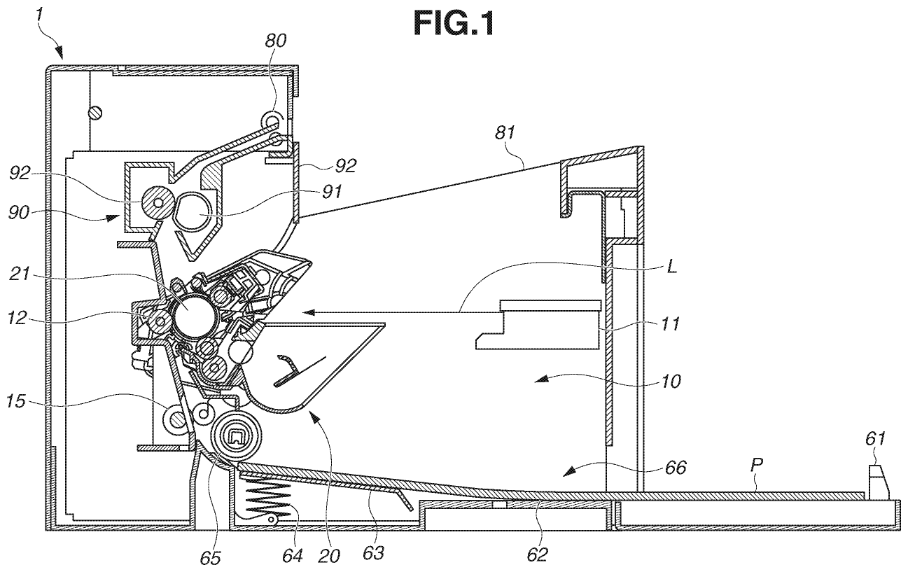

FIG. 1 illustrates an image forming apparatus 1 according to an embodiment. FIG. 1 is a cross-sectional view illustrating the image forming apparatus 1. As illustrated in FIG. 1, the image forming apparatus 1 includes an image forming portion 10, a feeding portion 66, a fixing portion 90, and a discharge roller pair 80. The image forming portion 10 is configured to form a toner image on a recording material P. The feeding portion 66 is configured to feed the recording material P to the image forming portion 10. The fixing portion 90 is configured to fix the toner image formed by the image forming portion 10 to the recording material P.

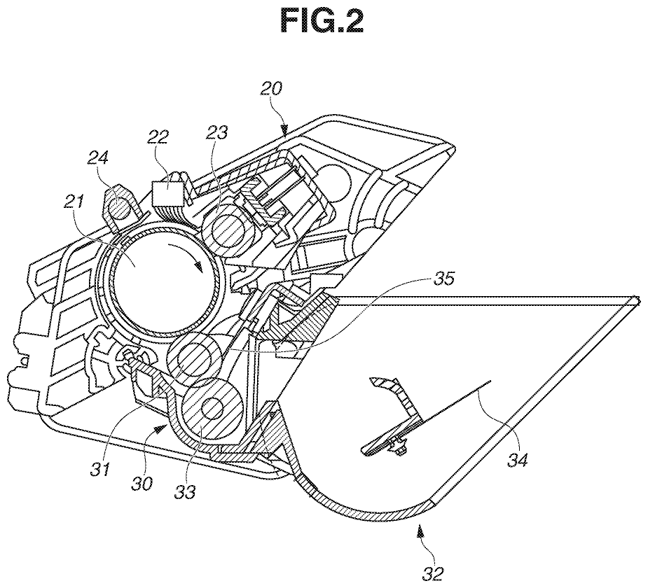

The image forming portion 10 includes a scanner unit 11, an electrophotographic process cartridge 20, and a transfer roller 12. The transfer roller 12 is configured to transfer a toner image formed on a photosensitive drum 21 of the process cartridge 20 to the recording material P. FIG. 2 is a detailed view illustrating the process cartridge 20. The process cartridge 20 includes the photosensitive drum 21, a drum unit 20, a pre-exposure device 24, and a developing device 30. The drum unit 20 includes a charging brush 22 and a charging roller 23 around the photosensitive drum 21. The developing device 30 includes a developing roller 31. The process cartridge 20 is configured to be attached to and detached from the image forming apparatus 1. It may be noted that the process cartridge 20 may be configured to be mounted in the image forming apparatus 1, or the drum unit 20 serving as a drum cartridge and the developing device 30 serving as a developing cartridge may be configured to be attached to and detached from the image forming apparatus 1 independently of each other.

In a case where an image forming instruction is input to the image forming apparatus 1, the image forming portion 10 starts an image forming process based on image information input from an external computer connected to the image forming apparatus 1.

The photosensitive drum 21 serving as an image bearing member is driven and rotated at a predetermined process speed in a predetermined direction (clockwise direction in FIG. 2) by a motor (driving unit) 60 serving as a driving unit.

Each of the charging brush 22 and the charging roller 23 serving as a charging member is brought into contact with the photosensitive drum 21 with a predetermined pressing force, and a charging power supply 71 serving as a charging high-voltage applying unit in FIG. 2 applies a desired charging voltage to the charging brush 22 and the charging roller 23, thereby uniformly charging a surface of the photosensitive drum 21 to a predetermined potential. The pre-exposure device 24 discharges the surface of the photosensitive drum 21 before the surface enters a charging portion, thereby ensuring stable charging by the charging brush 22 and the charging roller 23. Details of the charging brush 22 and the charging roller 23 will be described below.

The scanner unit 11 serving as an exposure device or an exposure unit emits laser light to the photosensitive drum 21 using a polygon mirror based on the input image information to scan and expose the photosensitive drum 21, thereby forming an electrostatic latent image on the photosensitive drum 21. It may be noted that the scanner unit 11 is not limited to a laser scanner device and may be, for example, a light-emitting diode (LED) exposure device including an LED array with a plurality of LEDs arranged in a longitudinal direction of the photosensitive drum 21.

The electrostatic latent image formed on the photosensitive drum 21 is developed by the developing device 30, thereby forming a toner image on the photosensitive drum 21.

The developing device 30 will be described in detail with reference to FIG. 2. The developing device 30 serving as a developing device includes toner, a toner bearing member, the developing roller 31, a developing container 32, and a supply roller 33. The toner bearing member is configured to bear a developing agent. The developing roller 31 serves as a developing agent bearing member. The developing container 32 serves as a frame of the developing device 30. The supply roller 33 is configured to supply the toner to the developing roller 31. The developing roller 31 and the supply roller 33 are rotatably supported by the developing container 32. Further, the developing roller 31 is disposed in an opening portion of the developing container 32 so that the developing roller 31 faces the photosensitive drum 21. In the present embodiment, the surface of the photosensitive drum 21 is in contact with a surface of the developing roller 31, thereby forming a developing portion. Further, at the developing portion, the toner borne on the developing roller 31 is supplied to the surface of the photosensitive drum 21. The surface of the developing roller 31 and the surface of the photosensitive drum 21 move in the same direction. In other words, the developing roller 31 and the photosensitive drum 21 rotate in opposite directions. Furthermore, in the present embodiment, the surface of the photosensitive drum 21 and the surface of the developing roller 31 are configured to be in constant contact with each other. In other words, no contact/separation mechanism configured to separate the surface of the photosensitive drum 21 and the surface of the developing roller 31 or bring the surfaces into contact is provided. The supply roller 33 is in contact with the developing roller 31 so that the supply roller 33 can rotate, and the toner stored in the developing container 32 is applied to the surface of the developing roller 31 by the supply roller 33.

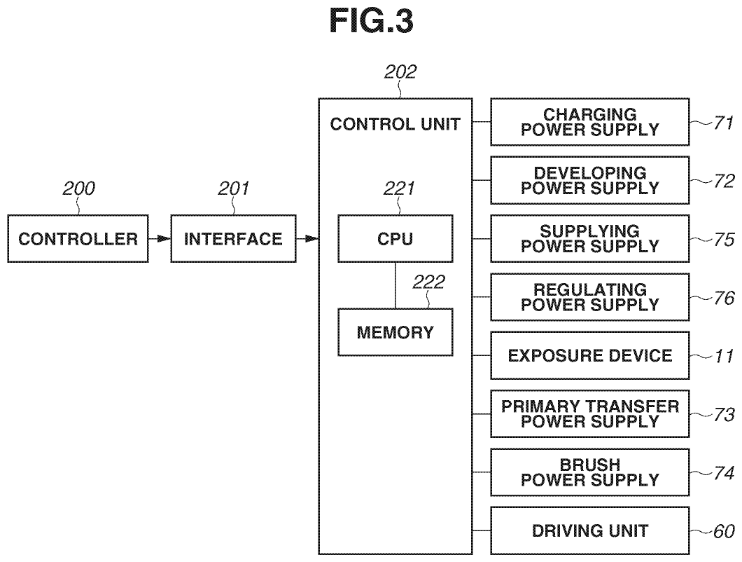

A developing power supply 72 in FIG. 3 serving as a developing voltage applying unit applies a developing voltage to the developing roller 31, and a supplying power supply 75 in FIG. 3 serving as a supply voltage applying unit applies a supply voltage to the supply roller 33.

An agitating member 34 serving as an agitating unit is provided inside the developing container 32. The agitating member 34 is driven and rotated, thereby agitating the toner stored in the developing container 32 and supplying the toner to the developing roller 31 and the supply roller 33. Further, the agitating member 34 has a role of circulating the toner removed from the developing roller 31 without being used for development in the developing container 32 and homogenizing the toner in the developing container 32. In the present embodiment, the agitating member 34 rotates clockwise as illustrated in FIG. 2. The agitating member 34 may rotate counterclockwise.

Further, a developing blade 35 is disposed in the opening portion of the developing container 32 where the developing roller 31 is disposed. The developing blade 35 is formed of a stainless steel (SUS) plate configured to regulate the amount of toner borne on the developing roller 31. A regulating power supply 76 in FIG. 3 serving as a regulating voltage applying unit may apply a regulating voltage to the developing blade 35. The regulating voltage is different from the developing voltage applied to the developing roller 31.

As the developing roller 31 rotates, the toner supplied to the surface of the developing roller 31 passes through a portion facing the developing blade 35, thereby forming a uniform thin layer.

The developing device 30 in the present embodiment employs a contact development method. In other words, the toner layer borne on the developing roller 31 is brought into contact with the photosensitive drum 21 at a developing portion (developing region) at which the photosensitive drum 21 and the developing roller 31 face each other. In the present embodiment, the photosensitive drum 21 is driven to rotate at a surface speed of 300 mm/sec by a driving unit (motor) 60 illustrated in FIG. 3, and the surface speed of the developing roller 31 is different from the surface speed of the photosensitive drum 21 by 40% (hereinafter, the difference will be referred to as “developing peripheral speed difference”). Accordingly, the developing roller 31 rotates at a speed 40% higher than the photosensitive drum 21. In other words, the moving speed of the surface of the developing roller 31 is set to 1.4 times the moving speed of the surface of the photosensitive drum 21. When the rotation speed of the photosensitive drum 21 is 100%, the rotation speed of the developing roller 31 is 140%. The developing peripheral speed ratio, defined as the ratio of the rotation speed of the developing roller 31 to the rotation speed of the photosensitive drum 21, is 140%. Accordingly, the photosensitive drum 21 and the developing roller 31 are brought into contact with each other with a speed difference of 120 mm/sec. The developing peripheral speed ratio is not limited to 140%. Further, the rotation speed of the developing roller 31 may be set as appropriate. The developing power supply 72 applies the developing voltage to the developing roller 31. While the developing voltage is applied, the toner borne on the developing roller 31 is transferred from the developing roller 31 to the surface of the photosensitive drum 21 in accordance with the potential distribution on the surface of the photosensitive drum 21. As a result, the electrostatic latent image is developed into a toner image. It may be noted that the present embodiment employs a reversal development method. In other words, the toner adheres to a surface region of the photosensitive drum 21 in which the charge has been reduced by exposure after charging, thereby forming a toner image.

The toner used in the present embodiment is a toner that has a mean particle size of 6 μm and a normal charging polarity that is negative. For example, a polymerization toner produced by a polymerization method is employed. A so-called single-component non magnetic developing agent that contains no magnetic component and is borne on the developing roller 31 primarily by an intermolecular force or an electrostatic force (image force) is used. The toner and an additive, such as an external additive, are combined to form a developing agent. For convenience, the toner may also be referred to as the developing agent.

Toner particles contain a plurality of waxes to adjust a melting characteristic of the toner during a fixing process and adhesion to a printing medium and a fixing roller.

Fine particles including silica particles having a particle size in the submicron range are added to the surface of the toner particles to adjust flowability and charging performance of the toner.

It may be noted that while the non-magnetic single-component developing agent is described as an example in the present embodiment, a single-component developing agent containing a magnetic component may be used. Further, a two-component developing agent including a non-magnetic toner and a magnetic carrier may be used as the developing agent. In a case where a magnetic developing agent is used, for example, a cylindrical developing sleeve in which a magnet is disposed may be used as a developing agent bearing member.

Concurrently with the image forming process, the recording material P stored in the feeding portion 66 is fed in synchronization with the transfer timing of the toner image. The feeding portion 66 includes a front door 61, a stacking tray 62, a middle plate 63, a tray spring 64, and a pickup roller 65. The front door 61 is supported by the image forming apparatus 1 so that the front door 61 can be opened and closed. The stacking tray 62 constitutes a bottom surface of a recording material storage space configured to appear when the front door 61 is opened, and the middle plate 63 is supported by the stacking tray 62 so that the middle plate 63 is vertically movable.

The tray spring 64 biases the middle plate 63 upward, thereby pressing the recording material P stacked on the middle plate 63 against the pickup roller 65. It may be noted that the front door 61 in a closed state with respect to the image forming apparatus 1 closes the recording material storage space whereas the front door 61 in an opened state with respect to the image forming apparatus 1 supports the recording material P together with the stacking tray 62 and the middle plate 63. The recording material P is conveyed by the following process. First, the pickup roller 65 of the feeding portion 66 feeds the recording material P supported by the front door 61, the stacking tray 62, and the middle plate 63. Next, the recording material P is conveyed to a registration roller pair 15 by the pickup roller 65 and brought into contact with a nip of the registration roller pair 15, thereby correcting skew. Then, the registration roller pair 15 is driven in synchronization with the transfer timing of the toner image and conveys the recording material P to a transfer nip formed by the transfer roller 12 and the photosensitive drum 21.

A primary transfer voltage power supply 73 applies a transfer voltage to the transfer roller 12 serving as a transfer unit, thereby transferring the toner image borne on the photosensitive drum 21 to the recording material P conveyed by the registration roller pair 15.

The recording material P with the transferred toner image is conveyed to the fixing portion 90, and the toner image is heated and pressed while passing through a nip portion between a fixing film 91 and a pressure roller 92 of the fixing portion 90.

As a result, the toner particles are melted and subsequently fused, thereby fixing the toner image to the recording material P.

The fixing portion 90 herein employs a heat-fixing method in which an image fixing process is performed by heating and melting the toner on the recording material P. The fixing portion 90 includes the fixing film 91, a fixing heater (not illustrated), a thermistor (not illustrated), and the pressure roller 92. The fixing heater is a ceramic heater or the like and is configured to heat the fixing film 91. The thermistor is configured to measure the temperature of the fixing heater. The pressure roller 92 is configured to be pressed against the fixing film 91.

The recording material P that has passed through the fixing portion 90 is discharged from the image forming apparatus 1 by the discharge roller pair 80 and stacked on a discharge tray 81. The discharge tray 81 is upwardly inclined toward a downstream end in a discharge direction of the recording material P, and the recording material P discharged to the discharge tray 81 slides down the discharge tray 81, thereby aligning a trailing edge of the recording material P with a regulating surface 82.

It may be noted that while the process cartridge configured to be attached to and detached from a body of the image forming apparatus 1 is used in the present embodiment, this is not intended to be limiting. Any configuration that enables a predetermined image forming process to be performed may be employed. For example, while the developing cartridge configured so that the developing device 30 is attachable to and detachable from the developing cartridge and the drum cartridge configured so that the drum unit 20 is attachable to and detachable from the drum cartridge are described above, a configuration that uses a toner cartridge configured to externally supply toner to the developing device 30 may be employed.

It may be noted that while no cleaning member is provided to collect the toner remaining on the photosensitive drum 21 as a result of not being transferred to the recording material P during the transfer process in the present embodiment, this is not intended to be limiting, and a configuration that includes a cleaning member may be employed.

### [Charging Configuration]

A feature of the present embodiment is that the surface of the photosensitive drum 21 is charged using a combination of an injection charging method and a contact charging method. In other words, the surface of the photosensitive drum 21 is charged by a combination of a first charging member disposed upstream and a second charging member disposed downstream in a rotation direction of the photosensitive drum 21.

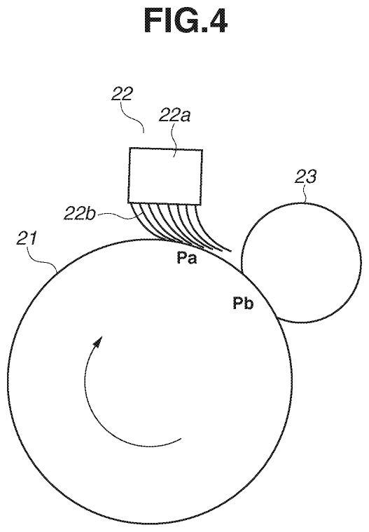

FIG. 4 illustrates a charging configuration according to the present embodiment. In the present embodiment, the charging brush 22 serving as the first charging member is brought into contact with a first charging portion Pa with a predetermined pressing force, and the charging roller 23 serving as the second charging member is brought into contact with a second charging portion Pb with a predetermined pressing force. The first charging portion Pa and the second charging portion Pb are circumferential positions of the photosensitive drum 21. The first charging portion Pa herein is located downstream of a transfer portion corresponding to the transfer nip and upstream of the second charging portion Pb in the rotation direction of the photosensitive drum 21.

A predetermined charging voltage is applied to the charging brush 22 to charge the surface of the photosensitive drum 21 using the injection charging method in accordance with the magnitude of a first charging potential difference formed between a surface potential of the photosensitive drum 21 at the position Pa and a brush voltage, which is a first charging voltage. A predetermined charging voltage is applied to the charging roller 23 to charge the surface of the photosensitive drum 21 by discharge in accordance with the magnitude of a second charging potential difference formed between a surface potential of the photosensitive drum 21 at the position Pb and a charging voltage, which is a second charging voltage.

### [Photosensitive Drum]

The photosensitive drum 21 is formed by providing a photosensitive material, such as an organic photosensitive member, amorphous selenium, or amorphous silicon, on a cylindrical drum base formed of aluminum, nickel, or the like.

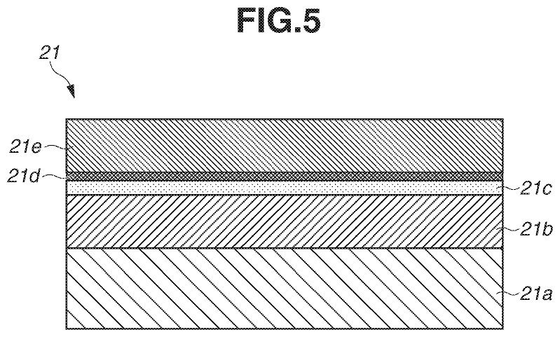

FIG. 5 is a cross-sectional view illustrating a structure of the photosensitive drum 21 employed in the present embodiment. The photosensitive drum 21 is a negatively chargeable organic photosensitive member having an outer diameter of 24 mm. As illustrated in FIG. 5, the photosensitive drum 21 includes a conductive support 21a, a conductive layer 21b, an undercoat layer 21c, and a two-layer photosensitive layer including a charge-generating layer 21d and a charge-transport layer 21e. The conductive support 21a is formed of an aluminum cylinder.

The photosensitive drum 21 further including a coating layer on the charge-transport layer 21e may be employed to suppress surface abrasion of the photosensitive drum 21 and to adjust a coefficient of friction.

### [Charging Roller]

The charging roller 23 serving as the second charging member has a multi-layer structure in which a stainless steel core metal having a diameter of 6 mm and serving as a support is covered with a plurality of flexible resin layers. In the present embodiment, the charging roller 23 has a two-layer structure including a base layer serving as a first resin layer covering the core metal and a surface layer serving as a second resin layer covering the base layer. A resin material of the base layer is conductive Hydrin rubber in which conductive carbon is dispersed, and the base layer is formed on the core metal by extrusion molding and has a thickness of approximately 2 mm. While the present embodiment employs the conductive Hydrin rubber, this is not intended to be limiting, and any resin material having flexibility and conductivity may be employed.

A high-resistance resin layer having a thickness of approximately 30 μm and a suitable surface roughness is applied by spray coating as the surface layer on the base layer of the charging roller 23. With the outermost surface having high resistance, the movement of charges from the charging roller 23 to the photosensitive drum 21 is suppressed. In this configuration, a urethane-based resin material is mixed with urethane-based roughening particles having a particle size of approximately 20 μm in an amount of approximately 50% by weight to provide the surface with a suitable surface roughness, thereby preparing a coating liquid for the surface layer. The surface layer is formed by applying the coating liquid to the base layer by spray coating. The surface layer has a volume resistivity of approximately 1×10⁵ Ω·cm, and the surface has an arithmetic average roughness Ra of approximately 2 μm.

The volume resistivity of the surface layer of the charging roller 23 can be 1.0×10⁴ Ω·cm or more and 1.0×10⁷ Ω·cm or less, and the arithmetic average roughness Ra of the surface can be from 0.5 μm to 3.0 μm. In a case where the volume resistivity of the charging roller 23 is significantly low, an overcurrent may cause a leakage current to flow through the photosensitive drum 21. Further, in a case where the volume resistivity of the charging roller 23 is significantly high, it is difficult to apply the charging voltage to the surface of the charging roller 23, which may cause the discharge for uniform charging to become unstable. Accordingly, the volume resistivity of the charging roller 23 can be set within the above-described range. Further, when the surface roughness is within the above-described range, stable uniform charging is facilitated. Accordingly, the surface roughness can be set within the above-described range.

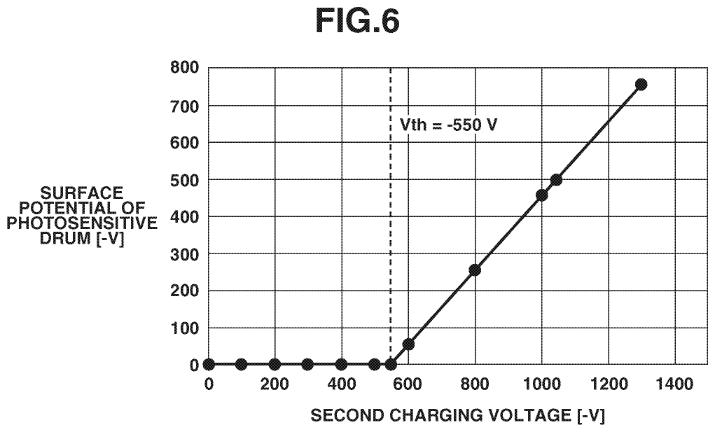

FIG. 6 illustrates a charging characteristic obtained when the surface of the photosensitive drum 21 is charged by the charging roller 23 in an environment at a temperature of 32.5° C. and a humidity of 80%. In other words, FIG. 6 illustrates a relationship between a direct current (DC) charging voltage applied to the charging roller 23 and a surface potential of the photosensitive drum 21 in a case where the charging roller 23 serving as a charging member is brought into pressurized contact with the photosensitive drum 21. The surface potential of the photosensitive drum 21 was measured using a voltmeter (TREK Model 344-F) and a sideview probe (TREK Model 6000B-8) for the voltmeter. In a case where the charging voltage is applied to the charging roller 23 in the present embodiment so that the second charging voltage becomes −550 V or greater, a uniform negative potential is formed on the surface of the photosensitive drum 21 by the contact charging method. A discharge start voltage Vth between the charging roller 23 and the photosensitive drum 21 herein is −550 V. As illustrated in FIG. 6, in a case where a charging voltage of approximately −550 V or greater is applied to the charging roller 23, the surface potential of the photosensitive drum 21 increases linearly with a slope of 1. This threshold is the voltage (hereinafter, referred to as “discharge start voltage”) at which charging accompanied by discharge starts. To form a dark potential Vd, which is the surface potential of the photosensitive drum 21, it is required to apply a DC voltage greater than or equal to Vd+Vth to the charging roller 23, where Vth is the discharge start voltage. The foregoing method in which only the DC voltage is applied to the contact charging member to charge the photosensitive drum 21 is referred to as the contact DC charging method.

It may be noted that, as described above, unless otherwise specified, voltages or potentials of greater or less (higher or lower) magnitudes are based on comparisons of their absolute values. In other words, with respect to potentials and applied voltages, a greater absolute value in the negative polarity direction (e.g., −1000 V with respect to −500 V) is referred to as a greater potential, and a smaller absolute value in the negative polarity direction (e.g., −300 V with respect to −500 V) is referred to as a smaller potential. This is because negatively chargeable toner is used as a reference in the present embodiment. Further, a voltage is defined as a potential difference with respect to ground potential (0 V). Accordingly, a developing voltage of −300 V indicates that a potential difference of −300 V with respect to the ground potential is formed by the developing voltage applied to the core metal of the developing roller 31. The same applies to other voltages such as the charging voltage.

### [Conductive Brush]

The charging brush 22 serving as the first charging member is formed by bonding and fixing a pile fabric formed of conductive nylon fibers 22b and having a width of 5 mm to a stainless steel plate 22a also serving as a power-supply electrode. The conductive nylon fibers 22b have a linear density of 2 deniers, a pile density of 200 kF/inch², and a pile length of 4 mm, and are in contact with the photosensitive drum 21 so that a fiber tip penetration depth is 0.6 mm. The unit kF/inch² used to express the pile density represents the number of filaments per square inch. A brush portion formed of the conductive nylon fibers 22b may be referred to simply as the brush portion.

A resistance value of the charging brush 22 is measured by pressing the stainless steel plate 22a from vertically above the charging brush 22 to have a penetration depth of 1 mm and applying a voltage between the stainless steel plate 22a and a base plate. The applied voltage is +250 V, and the resistance value measured five seconds after application of the voltage is defined as a brush resistance. The resistance is measured using a HIOKI ST5520. In the present embodiment, the brush resistance is from 1.0×10⁴Ω to 1.0×10⁶Ω. The brush resistance is controllable to a desired value by changing the material and amount of conductive particles dispersed in the conductive pile yarn.

The brush resistance value of the charging brush 22 can be from 1.0×10²Ω to 1.0×10⁸Ω. In a case where the brush resistance is significantly high, the flow of current is impeded, and it may be difficult to adequately charge the surface of the photosensitive drum 21. Further, in a case where the brush resistance is significantly low, a high current flows locally from the charging brush 22 to the photosensitive drum 21, and dielectric breakdown may occur in the photosensitive layers 21d and 21e of the photosensitive drum 21, which is so-called pinhole leaks. Accordingly, the brush resistance value can be set within the above-specified range.

A contact pressure of the charging brush 22 can be from 40 gf to 200 gf. The charging brush 22 is disposed so that the tip of a brush portion (conductive nylon fibers) 22b is in substantially uniform contact with the photosensitive drum 21 and rotation of the photosensitive drum 21 reduces fiber tip variation. In a case where the contact pressure of the brush portion 22b is significantly high, the charging brush 22 may cause a scratch or the like on the photosensitive drum 21.

Further, the present embodiment employs a cleanerless configuration in which no cleaning member for removing the developing agent remaining on the surface of the photosensitive drum 21 is provided. In the cleanerless configuration, in a case where the contact pressure between the charging brush 22 and the photosensitive drum 21 is high, untransferred toner remaining on the photosensitive drum 21 may be blocked by the charging brush 22, which may cause contamination of the brush portion 22b or a reduction in charging performance.

Further, in a case where the contact pressure of the brush portion 22b is significantly low, uniform contact of the brush portion 22b may not occur, and rotation of the photosensitive drum 21 may cause the brush portion 22b to tilt or move.

Accordingly, the contact pressure of the brush portion 22b can be set within the above-described range.

Further, while the charging brush 22 is bonded to a flexible sheet and brought into contact with the photosensitive drum 21 with a predetermined pressure in the present embodiment, springs or the like may be configured to apply pressure to both ends of a support of the charging brush 22 to bring the charging brush 22 into contact with the photosensitive drum 21. Further, the charging brush 22 may be fixed to a cartridge frame and brought into contact with the photosensitive drum 21 to have a predetermined penetration depth.

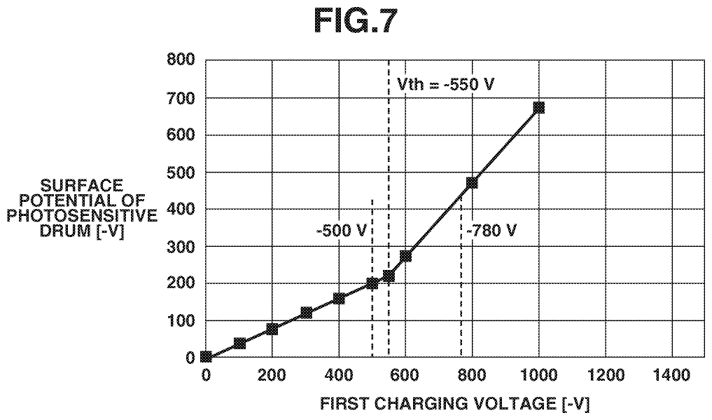

FIG. 7 illustrates a charging characteristic obtained when the surface of the photosensitive drum 21 is charged by the charging brush 22 in an environment at a temperature of 32.5° C. and a humidity of 80%. With the charging brush 22 according to the present embodiment, even in a case where the first charging voltage is equal to or less than the discharge start voltage Vth, which is −550 V, a potential is gradually formed on the photosensitive drum 21 by injection charging. After the first charging voltage exceeds Vth, the charging brush 22 behaves similarly to the charging roller 23, and a surface potential of the photosensitive drum 21 is formed by discharge in addition to injection charging. Accordingly, the slope between the first charging voltage and the surface potential of the photosensitive drum 21 changes at the discharge start voltage Vth.

### Control Configuration of the Image Forming Apparatus

Next, a control configuration of the image forming apparatus 1 in the present embodiment will be described. FIG. 3 is a block diagram illustrating a control configuration of essential components of the image forming apparatus 1 in the present embodiment.

The image forming apparatus 1 includes a control unit 202 configured to control the operation of the image forming apparatus 1. Signals indicating various types of information are input to the control unit 202 and output from the control unit 202 via an electrical connection. The control unit 202 processes signals input from various processing devices and sensors, and signals output to command various processing devices to operate. A controller 200 of the image forming apparatus 1 receives various input signals from and outputs various signals to an external apparatus (host apparatus), and receives various input signals from and outputs various signals to the control unit 202 via an interface 201 of the image forming apparatus 1. The control unit 202 comprehensively controls the operation of the image forming apparatus 1 in accordance with a predetermined control program or a reference table based on an instruction from the controller 200.

The control unit 202 includes a central processing unit (CPU) 221 and a memory 222 of the main body. The CPU 221 serves as a computation processing unit that is a central element configured to perform various computations. The memory 222 serves as a storage unit configured to store information and includes storage devices such as a random access memory (RAM), a read-only memory (ROM), and a non-volatile memory. The RAM temporarily stores a detection result of the sensors, a count result of a counter, a computation result, and the like. Further, the ROM stores the control program, a data table obtained in advance through an experiment, and the like. Further, the non-volatile memory stores a count result of the counter, various types of setting information, a result of the sensors, and the like. Each controlled component of the image forming apparatus 1, the sensors, the counter, and the like are connected to the control unit 202. The control unit 202 controls input and output of various signals, the driving timing of each component, and the like, thereby controlling a predetermined image forming sequence and the like.

For example, the control unit 202 controls the charging power supply 71, the developing power supply 72, the supplying power supply 75, the regulating power supply 76, an exposure unit 11, a primary transfer power supply 73, the driving unit 60, a brush power supply 74, and the like.

Further, the driving unit 60 includes a drive motor, a drive-transmitting member, and the like. The drive motor serves as a driving source. The driving sources for the photosensitive drum 21 and a rotatable member of the developing device 30 may be provided independently, or at least a portion thereof may be shared. Further, the driving sources for driving elements for each color may be provided independently, or at least a portion thereof may be shared.

The image forming apparatus 1 herein performs an image forming operation (print job), which is a series of operations including forming an image on one or more recording materials P and outputting the one or more recording materials and is initiated by a single start instruction. In general, the image forming operation includes an image forming process, a preliminary process (pre-rotation process, pre-print operation), an inter-sheet process in a case where an image is formed on a plurality of recording materials P, and a subsequent process (post-rotation process, post-print operation). An image forming process refers to a period during which formation of an electrostatic latent image of an image to be formed on a recording material P and output, formation of a toner image, primary transfer of the toner image, and fixing are performed, and the term “image forming period” refers to this period. More specifically, timings during the image forming period differ depending on the positions at which the charging, exposure, developing, primary transfer, and fixing processes are performed. The preliminary process refers to a period during which a preparation operation prior to the image forming process is performed after a start instruction is input and before image formation is started. The inter-sheet process refers to a period between recording materials P in a case where image formation is continuously performed on a plurality of recording materials P (continuous image formation). The post-rotation process refers to a period during which a finishing operation (preparation operation) after the image forming process is performed. A non-image forming period refers to a period outside the image forming period and includes the preliminary process, the inter-sheet process, the subsequent process, and other processes such as a pre-multiple-rotation process, which is a preparation operation performed when the image forming apparatus 1 is powered on or resumes from a sleep state.

### Charging Voltage Control During the Image Forming Operation

Voltage control during the image forming operation in the present embodiment will be described. During the image forming operation, the surface potential of the photosensitive drum 21 is discharged by the pre-exposure device 24, and the surface potential at the first charging portion Pa is approximately 0 V. A charging voltage of −500 V is applied to the charging brush 22, and the first charging voltage has a magnitude of −500 V, so that the surface of the photosensitive drum 21 is charged to −200 V by the injection charging method in accordance with the characteristic illustrated in FIG. 7. The surface potential of the photosensitive drum 21 at the second charging portion Pb is charged to −200 V, and a charging voltage of −1000 V is applied to the charging roller 23, so that the second charging potential difference has a magnitude of −800 V. At this time, the surface of the photosensitive drum 21 is charged to −250 V by the contact DC charging method in accordance with the characteristic illustrated in FIG. 6, and ultimately, the surface of the photosensitive drum 21 reaches −450 V. In other words, a surface potential of −450 V corresponding to the difference from the discharge start voltage Vth, which is −550 V, is formed at the first charging portion Pa as a result of applying −1000 V following the injection of −200 V.

A developing voltage of −300 V is applied to the developing roller 31 herein, and the potential difference between the photosensitive drum 21 and the developing voltage (the surface potential of the developing roller 31), i.e., back contrast, is set to −150 V.

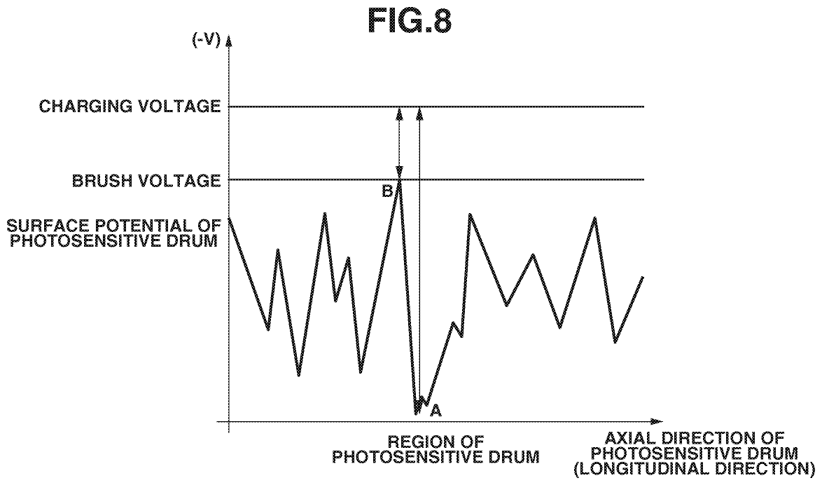

In the injection charging method herein, since the surface of the photosensitive drum 21 is charged only at the portion in direct contact with the charging brush 22, non-uniform charging may occur if the photosensitive drum 21 and the charging brush 22 are not in uniform contact. The non-uniform charging will be described below with reference to FIG. 8. In the contact DC charging method, on the other hand, the photosensitive drum 21 is charged by discharge generated in a non-contact portion. This enables charging at a gap near the second charging portion Pb where the photosensitive drum 21 and the charging roller 23 are not in contact, thereby enabling uniform charging.

Accordingly, although the surface potential of the photosensitive drum 21 charged by the injection charging method may be non-uniform, the surface of the photosensitive drum 21 is uniformly charged by the contact DC charging method using the charging roller 23.

As described above, the second charging member can charge the surface of the photosensitive drum 21 using the contact DC charging method during the image forming operation, and the second charging potential difference can be greater than or equal to the discharge start voltage.

### Effects of Products Generated by Discharge on the Photosensitive Drum

When the image forming operation is performed using the image forming apparatus 1, small amounts of products such as ozone or NOx may be generated by discharge from the charging roller 23. The discharge products may accumulate on the surface of the photosensitive drum 21 depending on a usage condition, such as repeated use of the image forming apparatus 1.

In particular, in a high-temperature, high-humidity environment, if the discharge products accumulated on the surface of the photosensitive drum 21 absorb moisture, the electrical resistance of the surface of the photosensitive drum 21 may decrease, which may make it difficult to maintain a formed electrostatic latent image. Consequently, an “image flow”, which is an image defect in which the toner image becomes blurred, may occur.

It is known that the amount of discharge products depends on the magnitude of the amount of discharge. Meanwhile, the discharge products on the photosensitive drum 21 are removed by a member in contact with the photosensitive drum 21. In other words, the amount of discharge products accumulated on the photosensitive drum 21 relates to the magnitude of the amount of discharge, the amount removed by a contact member such as the developing roller 31, a usage history of the image forming operation, and the like.

A feature of the present embodiment is that the amount of discharge during the non-image forming operation is reduced to reduce the amount of discharge products accumulated on the photosensitive drum 21. In other words, the second charging potential difference during the non-image forming operation is less than the second charging potential difference during the image forming operation.

Specifically, the brush voltage is controlled to increase in the direction of the charging polarity (normal polarity) of the toner so that the surface potential between the first charging portion Pa and the second charging portion Pb in the rotation direction of the photosensitive drum 21 during the non-image forming operation is greater in absolute value than the surface potential between the first charging portion Pa and the second charging portion Pb in the rotation direction of the photosensitive drum 21 during the image forming operation.

Further, the second charging voltage applied to the charging roller 23 can be decreased during the non-image forming operation to further decrease the second charging potential difference.

Further, the second charging potential difference can be controlled so that the second charging potential difference is less than the discharge start voltage Vth to minimize the amount of discharge products.

Further, in the injection charging method using the charging brush 22, small non-uniform charging may occur in the surface potential between the first charging portion Pa and the second charging portion Pb of the photosensitive drum 21, as described above. At this time, even in a case where the second charging potential difference is controlled so that the second charging potential difference is less than or equal to the discharge start voltage Vth, small discharge may occur, which may make it difficult to completely suppress the generation of discharge products.

In this case, a situation illustrated in FIG. 8 occurs due to the non-uniformity in the surface potential of the photosensitive drum 21 injected by the first charging voltage, which is the brush voltage applied to the charging brush 22. A state of the potential formed on the surface of the photosensitive drum 21 will be described in detail with reference to FIG. 8. FIG. 8 illustrates changes in the surface potential of the photosensitive drum 21 in an axial direction (longitudinal direction) in a case where the surface of the photosensitive drum 21 charged by injection from the charging brush 22 is brought into contact with the charging roller 23 as the photosensitive drum 21 rotates. From FIG. 8, it is understood that the potential formed on the surface of the photosensitive drum 21 charged by injection from the charging brush 22 is in an unstable state. This phenomenon appears due to a local difference in impedance between the charging brush 22 and the photosensitive drum 21. In other words, the impedance of the contact region between the charging brush 22 and the photosensitive drum 21 is not necessarily uniform, and the current flowing toward the surface of the photosensitive drum 21 flows more readily in some regions and less readily in other regions. The contact surface between the charging brush 22 and the photosensitive drum 21 also has differences in the surface resistance of the photosensitive drum 21 and in the contact state of the charging brush 22. Thus, although the surface potential is fairly uniform, the situation illustrated in FIG. 8 may occur depending on an environmental or usage condition. As a result of charging by injection from the charging brush 22, a surface potential smaller than an injection potential expected from the brush voltage applied to the charging brush 22 may be formed on the photosensitive drum 21 as observed at a point A in FIG. 8. For example, in a case where the contact surface between the charging brush 22 and the photosensitive drum 21 includes a portion with a locally increased impedance in a low-temperature, low-humidity environment, injection may be suppressed. In this case, the surface potential Vd of the photosensitive drum 21 has a smaller absolute value than expected. Thus, depending on the charging voltage applied to the charging roller 23, discharge may be generated due to a potential difference between the surface region of the photosensitive drum 21 where the amount of injection is small and the charging voltage applied to the charging roller 23. Thus, the charging voltage applied to the charging roller 23, which is the second charging voltage, can be greater in absolute value than the brush voltage applied to the charging brush 22, which is the first charging voltage, and the potential difference can be controlled to prevent discharge. Specifically, control can be performed so that the second charging voltage applied during the non-image forming operation is less in absolute value than the second charging voltage applied during the image forming operation.

Further, in this situation, the amount of generated discharge products can be further reduced by measuring a current value during application of the charging voltage to the charging roller 23 and setting the charging voltage to a value less than a charging voltage at which a current begins to flow due to small discharge. Specifically, a charging current detection unit (charging current detection circuit) configured to detect a charging current flowing through the second charging portion Pb (the charging roller 23, the charging power supply 71) may be provided.

While the amount of discharge is reduced by performing control to increase the charging voltage applied to the charging brush 22 in the present embodiment, this is not intended to be limiting. The second charging potential difference during the non-image forming operation may be less than the second charging potential difference during the image forming operation. For example, the amount of discharge may be reduced by changing the charging voltage applied to the charging roller 23 without changing the brush voltage applied to the charging brush 22.

### Proper Potential Relationship Between Each Member and the Photosensitive Drum Surface

As described above, the surface of each member may become contaminated as a result of repeated use of the image forming apparatus 1. The term “a surface is contaminated” refers to the transfer of a substance, such as the toner, an external additive, or a discharge product adhering to the surface of the photosensitive drum 21, to each member during the image forming operation due to a potential difference between the photosensitive drum 21 and the member. In a case where the substance is charged to the same polarity as that of the toner, the substance is transferred mainly to the transfer roller 12 to which a positive-polarity voltage, which is a voltage of a polarity opposite to that of the toner, is applied during the image forming operation. On the other hand, in a case where the substance is charged to a polarity opposite to that of the toner, the substance is transferred to the charging brush 22 or the charging roller 23 to which a negative-polarity voltage, which is a voltage of the same polarity as that of the toner, is applied.

At this time, for example, if the potential difference relationship between the voltage applied to the charging roller 23 and the surface potential of the photosensitive drum 21 during the non-image forming operation is reversed with respect to that during the image forming operation, the substance charged to a polarity opposite to that of the toner and adhering to the charging roller 23 may be transferred to the photosensitive drum 21. In the present embodiment, the charging voltage during the image forming operation is −1000 V, and the surface potential of the photosensitive drum 21 at the second charging portion Pb is −450 V. Thus, during the image forming operation, a potential difference is formed, which may cause the substance charged to a positive polarity opposite to that of the toner to adhere to the charging roller 23. Thereafter, if the charging voltage is changed to 0 V during the non-image forming operation, the substance adhering to the charging roller 23 may be transferred to the surface of the photosensitive drum 21 in a case where the surface potential of the photosensitive drum 21 at the second charging portion Pb is greater than 0 V in the direction of the normal polarity of the toner. Consequently, an image defect or the like may occur. Thus, during the non-image forming operation, a potential can be formed on the surface of the photosensitive drum 21, and the potential relationship between each member and the surface of the photosensitive drum 21 can be controlled so that an electric field direction is the same as that during the image forming operation. At this time, it is unnecessary to form a toner image during the non-image forming operation. Thus, even if small non-uniform charging occurs in the surface potential formed on the photosensitive drum 21, this is acceptable in practical use.

As described above, during the non-image forming operation, the voltage applied to the charging brush 22 can be greater in absolute value in the direction of the normal polarity of the toner, and the voltage applied to the charging roller 23 can be greater in absolute value in the direction of the normal polarity of the toner, with respect to the surface potential of the photosensitive drum 21. In other words, during the non-image forming operation, an electric field in the direction of movement of the toner charged to the normal polarity from the charging brush 22 to the surface of the photosensitive drum 21 can be formed between the charging brush 22 and the surface of the photosensitive drum 21.

Further, during the non-image forming operation, an electric field in the direction of movement of the toner charged to the normal polarity from the charging roller 23 to the surface of the photosensitive drum 21 can be formed between the charging roller 23 and the surface of the photosensitive drum 21. It may be noted that while the toner is described as a substance to be moved, another substance described above may be moved. Further, in a case where the substance is charged to a polarity opposite to the normal polarity, the direction of the electric field between the surface of the photosensitive drum 21 and the charging brush 22 and the direction of the electric field between the surface of the photosensitive drum 21 and the charging roller 23 are controlled to be reversed with respect to the above-described relationships.

Further, in the present embodiment, the surface of the developing roller 31 and the surface of the photosensitive drum 21 are configured to remain in contact without being separated during the non-image forming operation. Accordingly, in a case where a voltage of the same polarity as the normal polarity of the toner is applied during the non-image forming operation, as a condition for the developing voltage, the absolute value can be controlled to be less than the surface potential of the photosensitive drum 21, and the back contrast can be set. At this time, the surface potential of the photosensitive drum 21 is formed by the charging brush 22 during the non-image forming operation. In this case, the surface potential of the photosensitive drum 21 includes a potential component formed by injection charging, so that the surface potential Vd of the photosensitive drum 21 may exhibit significant non-uniformity depending on an environmental or usage condition. Accordingly, in the present embodiment, in a case where a voltage of the normal polarity of the toner is applied to the developing roller 31 during the non-image forming operation, the absolute value can be controlled to be less than the surface potential of the photosensitive drum 21.

Further, the surface potential of the photosensitive drum 21 formed during the image forming operation can be substantially the same as the surface potential of the photosensitive drum 21 formed during the non-image forming operation. In other words, in the present embodiment, the amount of discharge generated during the non-image forming operation is reduced compared with that during the image forming operation. Furthermore, a non-image potential Vd substantially the same as a non-image potential Vd formed during the image forming operation is formed during the non-image forming operation. A reason therefor is that control other than charging is simplified and, at the same time, the surface of the developing roller 31 and the surface of the photosensitive drum 21 are configured to remain in contact without being separated during the non-image forming operation. In other words, it is necessary to set the back contrast, which is the difference A between the surface potential of the photosensitive drum 21 and the developing voltage applied to the developing roller 31, so that the back contrast is the same as that during the image forming operation. For example, in a case where the surface potential Vd of the photosensitive drum 21 is changed, it is necessary to change the developing voltage to maintain the back contrast at the developing portion. Although the developing voltage may be changed as Vd is changed, this may result in the control becoming slightly more complex. Further, as described above, in a case where the surface potential Vd of the photosensitive drum 21 has a small absolute value, a formed potential may become unstable, and the proper back contrast may not be formed. Accordingly, control may be performed so that the surface potential of the photosensitive drum 21 formed during the image forming operation is substantially the same as the surface potential of the photosensitive drum 21 formed during the non-image forming operation.

Further, the surface resistance of the photosensitive drum 21 may decrease depending on an operating environment or the usage history of the image forming apparatus 1, which may facilitate injection charging by the first charging member. Consequently, the surface potential of the photosensitive drum 21 at the second charging portion Pb may become greater in absolute value in the direction of the normal polarity of the toner than those under normal conditions. In this situation, control may be performed as described below so that the substance charged to a polarity opposite to the normal polarity of the toner and adhering to the second charging member is prevented from being transferred to the photosensitive drum 21. In other words, a charging voltage of the same polarity as the normal polarity of the toner can be applied to the first charging member and the second charging member, and the charging voltage applied to the second charging member can be greater in absolute value than the charging voltage applied to the first charging member.

Further details will be described with reference to FIG. 8. FIG. 8 illustrates changes in the surface potential of the photosensitive drum 21 in a case where the surface of the photosensitive drum 21 charged by injection from the charging brush 22 is brought into contact with the charging roller 23 as the photosensitive drum 21 rotates, as described above. As described above, although the surface potential of the photosensitive drum 21 formed by the charging brush 22 is fairly uniform, the situation illustrated in FIG. 8 may occur depending on an environmental or usage condition. As a result of charging by injection from the charging brush 22, a surface potential substantially the same as the brush voltage applied to the charging brush 22 may be formed on the photosensitive drum 21 as observed at a point B in FIG. 8. For example, in a case where the contact surface between the charging brush 22 and the photosensitive drum 21 includes a portion with a locally decreased impedance in a high-temperature, high-humidity environment, injection up to the brush voltage may occur. In this case, the surface potential Vd of the photosensitive drum 21 has a greater absolute value than expected. Accordingly, in the present embodiment, the charging voltage applied to the charging roller 23 is set to have the same polarity as that of the brush voltage and a greater absolute value than that of the brush voltage, thereby preventing the substance charged to the opposite polarity from being transferred to the photosensitive drum 21. In the present embodiment, the non-uniformity of Vd after passing through the first charging portion Pa in a case where a brush voltage of −500 V is applied is approximately 100 V. Further, the non-uniformity of Vd after passing through the first charging portion Pa in a case where a brush voltage of −780 V is applied is approximately 100 V. Accordingly, the potential difference between the points A and B in FIG. 8 is approximately 100 V.

### Charging Voltage Control During the Non-Image Forming Period

In view of the above, voltage control during the non-image forming operation in the present embodiment will be described. During the non-image forming operation, the surface potential of the photosensitive drum 21 at the first charging portion Pa is discharged to approximately 0 V by the pre-exposure device 24. A charging voltage of −780 V is applied to the charging brush 22, and the first charging potential difference has a magnitude of −780 V. Thus, the surface of the photosensitive drum 21 is charged to −450 V in accordance with the characteristic illustrated in FIG. 7 due to an effect of discharge in addition to the injection charging method.

It may be noted that in a case where the potential difference formed between the charging brush 22 and the surface of the photosensitive drum 21 exceeds 550 V, discharge may occur between the charging brush 22 and the photosensitive drum 21, and charging by direct charge injection may also occur simultaneously. Accordingly, even in a case where the potential difference between the charging brush 22 and the surface of the photosensitive drum 21 exceeds 550 V, the injection charging method can reduce the total amount of discharge, thereby reducing discharge products compared with the contact DC charging method alone.

While the surface potential of the photosensitive drum 21 at the second charging portion Pb herein is charged to −450 V, a charging voltage of −800 V is applied to the charging roller 23, and the second charging potential difference has a magnitude of −350 V. This corresponds to the surface potential of the photosensitive drum 21 at which a charging voltage of −350 V occurs in the characteristic illustrated in FIG. 6. Accordingly, the surface of the photosensitive drum 21 is not charged, and ultimately, the surface of the photosensitive drum 21 remains at −450 V. In other words, the second charging potential difference has a magnitude less than the discharge start voltage Vth, and no discharge occurs, so that no discharge product is generated. Furthermore, the charging voltage is greater in the direction of the normal polarity of the toner than the surface potential of the photosensitive drum 21. Thus, fine particles charged to a polarity opposite to the normal polarity of the toner and adhering to the charging brush 22 or the charging roller 23 are not transferred to the photosensitive drum 21. A developing voltage of −300 V is applied to the developing roller 31 herein, and the back contrast is set to −150 V. It may be noted that during the non-image forming operation, it is unnecessary to form a toner image, so that the back contrast may be set to minimize the amount of toner transfer from the developing roller 31 to the photosensitive drum 21. For example, the back contrast value set during the image forming operation may be different from the back contrast value set during the non-image forming operation. The control unit 202 may control the back contrast so that the back contrast during the non-image forming operation is greater than that during the image forming operation, or may control the back contrast so that the back contrast during the non-image forming operation is less than that during the image forming operation.

### Specific Voltage Control in the First Embodiment

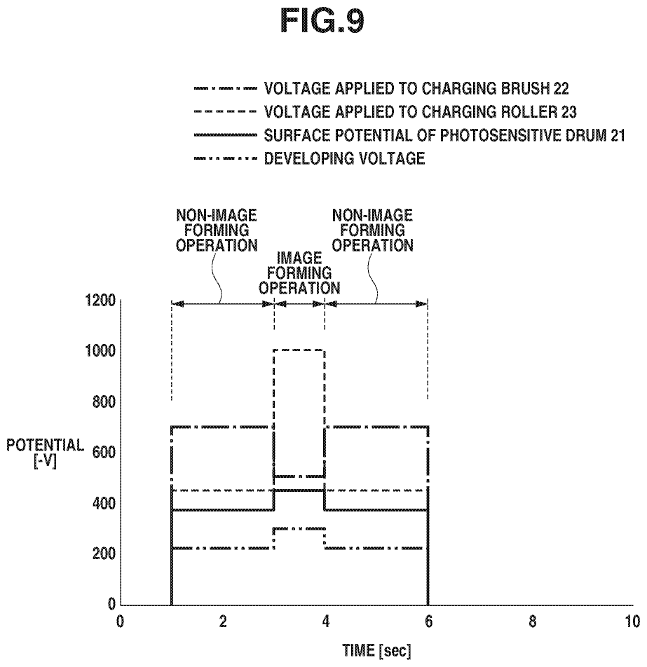

FIG. 9 illustrates a specific example of voltage control in Example 1-1, which will be described below, in a case where a single A4-size recording material P is printed. For convenience, voltage application timings are illustrated as changing simultaneously in FIG. 9. However, the timings may be slightly advanced or delayed, provided that preparation for the image forming operation is complete. Further, each voltage application timing and voltage application time may be set as appropriate.

A timing at which an image forming command is input to the control unit 202 of the image forming apparatus 1 from the controller 200 via the interface 201 is defined as an origin, and in the present embodiment, driving of the photosensitive drum 21 is started one second after the origin. Then, for two seconds prior to the start of the image forming operation, a surface potential of the photosensitive drum 21 is formed by voltage control during the non-image forming operation, and the developing voltage is applied to the developing roller 31. Then, once the image forming operation is started, the charging voltages applied to the charging brush 22 and the charging roller 23 are changed, and for approximately one second prior to the end of the image forming operation, a surface potential of the photosensitive drum 21 is formed by charging voltage control during the image forming operation, and the developing voltage is controlled to a predetermined value. For two seconds between the end of the image forming operation and the end of driving of the photosensitive drum 21, a surface potential of the photosensitive drum 21 is formed by charging voltage control during the non-image forming operation, and the developing voltage is controlled to a predetermined value. Once driving of the photosensitive drum 21 is stopped, the developing voltage control and the charging voltage control are stopped.

Specific charging voltages in the first embodiment will be described. The brush voltage, which is the first charging voltage applied during the image forming operation, is −500 V, and the charging voltage, which is the second charging voltage, is −1000 V. The first charging voltage and the second charging voltage during the non-image forming operation in the first embodiment are changed as follows.

In Example 1-1, the first charging voltage during the non-image forming operation is −700 V, and the second charging voltage during the non-image forming operation is −500 V. The surface potential of the photosensitive drum 21 when passing through the first charging portion Pa is −370 V, so that the potential difference at the second charging portion Pb is −130 V.

In Example 1-2, the first charging voltage during the non-image forming operation is −500 V, and the second charging voltage during the non-image forming operation is −500 V. The surface potential of the photosensitive drum 21 when passing through the first charging portion Pa is −200 V, so that the potential difference at the second charging portion Pb is −300 V.

In Example 1-3, the first charging voltage during the non-image forming operation is −780 V, and the second charging voltage during the non-image forming operation is −1000 V. The surface potential of the photosensitive drum 21 when passing through the first charging portion Pa is −450 V, so that the potential difference at the second charging portion Pb is −550 V.

In Example 1-4, the first charging voltage during the non-image forming operation is −780 V, and the second charging voltage during the non-image forming operation is −800 V. The surface potential of the photosensitive drum 21 when passing through the first charging portion Pa is −450 V, so that the potential difference at the second charging portion Pb is −350 V.

In Example 1-5, the first charging voltage during the non-image forming operation is −500 V, and the second charging voltage during the non-image forming operation is −750 V. The surface potential of the photosensitive drum 21 when passing through the first charging portion Pa is −2000 V, so that the potential difference at the second charging portion Pb is −550 V.

Comparative Example 1 will be described to describe an effect of the first embodiment in more detail.

The configuration of Comparative Example 1 is the same as that of the first embodiment, except for the following voltage control during the non-image forming period.

### Voltage Control in Comparative Example 1

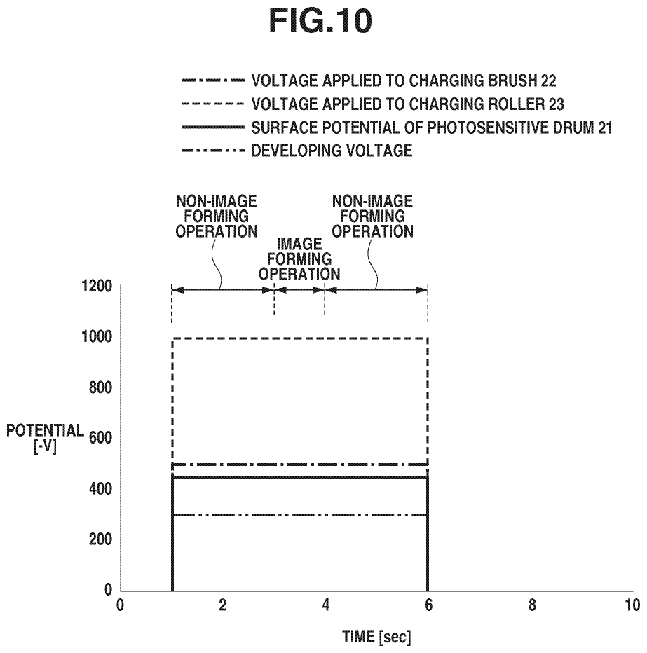

FIG. 10 illustrates a specific example of voltage control in Comparative Example 1 in a case where an A4-size recording material P is printed. The charging voltage control during the non-image forming period in Comparative Example 1 is similar to the voltage control during the image forming period in the first embodiment, and a charging voltage of −500 V is applied as the first charging voltage to the charging brush 22. A charging voltage of −1000 V is applied as the second charging voltage to the charging roller 23. A developing voltage of −300 V is applied to the developing roller 31. In other words, the voltage relationship during the non-image forming period in Comparative Example 1 is the same as the voltage relationship during the image forming operation.

### Advantage of the First Embodiment Over Comparative Example 1

### Comparative Evaluation of Durability

Table 1 presents durability evaluation results using the image forming apparatus described above.

### Durability Evaluation Method

Testing environment: temperature 32.5° C., humidity 80% Evaluation item: Three thousand A4-size recording materials P were fed in an intermittent operation of two sheets every two seconds and then allowed to sit for a day. Then, a halftone image was output, and an image flow evaluation and a contamination evaluation of the charging roller 23 were conducted. As described above, an image flow is an image defect in which the toner image becomes blurred, so that in a case where a decrease in halftone image density occurs, it is determined that an image flow has occurred. In other words, due to the dependence on the amount of discharge generated on the surface of the photosensitive drum 21, if the total amount of discharge increases, the image flow worsens.

Further, in a case where the potential difference between the charging roller 23 and the surface of the photosensitive drum 21 is not maintained at the second charging portion Pb, the positive-polarity toner, an external additive, and the like may be transferred from the surface of the charging roller 23. The transfer level from the charging roller 23 was also assessed.

TABLE 1

| | During Non-Image Forming Operation | | | | | | |
|---|---|---|---|---|---|---|---|
| | First | Second | Potential | First | Second | | Transfer |
| | Charging | Charging | Difference at the | Charging | Charging | Total | from the |
| | Voltage | Voltage | Second Charging | Amount of | Amount of | Amount of | Charging |
| | (V) | (V) | Portion Pb (V) | Discharge | Discharge | Discharge | Roller |
| Comparative | −500 | −1000 | −800 | B | D | D | B |
| Example 1 | | | | | | | |
| Example 1-1 | −700 | −500 | −130 | C | B | B | C |
| Example 1-2 | −500 | −500 | −300 | B | B | A | C |
| Example 1-3 | −780 | −1000 | −550 | C | C | B | B |
| Example 1-4 | −780 | −800 | −350 | C | B | B | B |
| Example 1-5 | −500 | −750 | −550 | B | C | B | B |

In Table 1, “A” indicates particularly excellent performance, “B” indicates an effective suppression with no practical issues, “C” indicates no issues in practical use, and “D” indicates problematic in practical use. The results are analyzed below. Analysis of the Results

In the first embodiment, the total amount of discharge is reduced compared with that in Comparative Example 1. A reason therefor is that the discharge caused by the second charging voltage is controlled so that the discharge during the non-image forming operation is reduced compared with that during the image forming operation. In other words, the potential difference formed at the second charging portion Pb during the non-image forming operation is less than the potential difference formed at the second charging portion Pb during the image forming operation. In Examples 1-1, 1-3, and 1-4, since the charging brush 22 causes a discharge, the amount of discharge caused by the charging brush 22 is slightly increased compared with those in Examples 1-2 and 1-5, but this causes no issues in practical use. A reason therefor is that as a result of performing injection charging by applying the brush voltage that causes the charging brush 22 to discharge, the amount of injection charging during the non-image forming operation increases compared with that during the image forming operation, so that the total amount of discharge is consequently reduced. In Comparative Example 1, on the other hand, the same charging voltage as that during the image forming operation is applied, so that the amount of discharge by the charging roller 23 serving as the second charging member increases, resulting in an image flow. In other words, the total amount of discharge exceeds an allowable range.

Items other than the discharge regarding the first embodiment will be analyzed in detail.

In Example 1-1, practical use is possible without issues with respect to the amount of discharge. However, the second charging voltage is less in absolute value than the first charging voltage, so that the potential difference at the second charging portion Pb is −130 V. Thus, a slight transfer of the positive-polarity toner or the like from the charging roller 23 was observed compared with other the first embodiment. This is caused by the failure to maintain the potential difference at the region where the amount of injection charging was locally increased as illustrated in FIG. 8. The results are attributable to the high-temperature, high-humidity testing environment in which the impedance readily decreases. In a case where the testing environment is a low-temperature, low-humidity environment in which the impedance is relatively high, local injection charging hardly occurs, and the transfer of the positive-polarity toner or the like from the charging roller 23 hardly occurs. Further, with respect to the Vd formation, Vd=−370 V is obtained, which is less in absolute value than Vd during the image forming operation, so that there are some development restrictions and the like. Specifically, it is necessary to reduce the developing voltage by 80 V in absolute value compared with that in the image forming operation. By considering the foregoing points, effective suppression of discharge is enabled in Example 1-1, thereby suppressing an image defect.

In Example 1-2, the second charging voltage is the same as the first charging voltage, and the brush voltage and the charging voltage are controlled to have small absolute values, so that the total amount of discharge is significantly reduced compared with the other Examples. However, as in Example 1-1, the potential difference at the second charging portion Pb is −300 V, which is slightly reduced. As a result, a region where the potential difference is locally reduced is formed. However, there are no issues in practical use. Further, with respect to the Vd formation, Vd=−200 V, which is less in absolute value than Vd during the image forming operation. Accordingly, the development restrictions are the greatest in the first embodiment. Specifically, it is necessary to reduce the developing voltage by 250 V in absolute value compared with that in the image forming operation. By considering the foregoing points, effective suppression of discharge is enabled in Example 1-2, thereby suppressing an image defect.

In Example 1-3, the second charging voltage is greater than the first charging voltage, and the second charging voltage is the same as that in the image forming operation, while the first charging voltage is greater than that in the image forming operation, thereby reducing the total amount of discharge. As described above, as a result of performing injection charging by applying the brush voltage that causes the charging brush 22 to discharge, the amount of injection charging during the non-image forming operation increases compared with that during the image forming operation. Thus, the total amount of discharge is consequently reduced. In Example 1-3, the potential difference at the second charging portion Pb is −550 V. With respect to the potential difference formed between the second charging voltage and the surface of the photosensitive drum 21, a slight discharge occurs locally in a region in which the amount of injection charging is small, as observed at the point B in FIG. 8. On the other hand, since the potential difference at the second charging portion Pb is −550 V, a sufficient potential difference is maintained between the charging roller 23 and the surface of the photosensitive drum 21, thereby suppressing the transfer of the positive-polarity toner and the like from the charging roller 23. Further, with respect to the Vd formation, since the first charging voltage is set to −780 V, Vd=−450 V is obtained solely by the effect of the first charging voltage, which is the same potential setting as that during the image forming operation. This makes it possible to establish the same potential relationship as that in the image forming operation, thereby avoiding restrictions on control such as development.

Accordingly, Example 1-3 is advantageous in that control is facilitated and a sufficient potential difference can be maintained at the second charging portion Pb, in addition to the discharge suppression effect.

In Example 1-4, as in Example 1-3, the second charging voltage is greater than the first charging voltage, and the first charging voltage is greater than that during the image forming operation, so that the total amount of discharge is reduced. Furthermore, in Example 1-4, the potential difference at the second charging portion Pb is −350 V. This makes it possible to maintain an appropriate potential difference between the charging roller 23 and the surface of the photosensitive drum 21, thereby suppressing discharge at the second charging portion Pb while suppressing the transfer of positive-polarity toner from the charging roller 23. Further, with respect to the Vd formation, the first charging voltage is set to −780 V as in Example 1-3.

This makes it possible to establish a similar potential relationship as that in the image forming operation, thereby avoiding restrictions on control such as development. Accordingly, Example 1-4 is further advantageous in that control is facilitated, an appropriate potential difference can be maintained at the second charging portion Pb, and the discharge caused by the second charging voltage can be suppressed, in addition to the discharge suppression effect.

In Example 1-5, the second charging voltage is greater than the first charging voltage, and the first charging voltage and the second charging voltage are both controlled to prevent discharge, thereby reducing the total amount of discharge. Further, the potential difference at the second charging portion Pb is −550 V as in Example 1-3, so that a sufficient potential difference is maintained between the charging roller 23 and the surface of the photosensitive drum 21. On the other hand, as in Example 1-3, a slight discharge occurs locally in a region in which the amount of injection charging is small. With respect to the Vd formation, Vd=−200 V is obtained, which is less in absolute value than Vd during the image forming operation, so that there are some control restrictions as in Example 1-2. However, Example 1-5 is advantageous in that the discharge caused by the first charging voltage is suppressed and a sufficient potential difference can be maintained at the second charging portion Pb, in addition to the discharge suppression effect.

Accordingly, the configuration of the first embodiment can achieve the above-described effects by including the following features.

The image forming apparatus 1 configured to perform the image forming operation to form an image on the recording material P includes the photosensitive drum 21 configured to rotate. The image forming apparatus 1 includes the charging brush 22 serving as the first charging member configured to be brought into contact with the surface of the photosensitive drum 21 to form the first charging portion Pa and charge the surface of the photosensitive drum 21 at the first charging portion Pa in a case where the brush voltage serving as the first charging voltage is applied.

The image forming apparatus 1 includes the charging roller 23 configured to charge the surface of the photosensitive drum 21 at the second charging portion Pb facing the surface of the photosensitive drum 21 in a case where a charging voltage serving as the second charging voltage is applied. The image forming apparatus 1 includes an exposure unit 11 configured to form an electrostatic latent image on the surface of the photosensitive drum 21 charged by the charging brush 22 and the charging roller 23. The image forming apparatus 1 includes the developing roller 31 serving as a developing member configured to develop the electrostatic latent image with a developing agent to form a developing agent image on the surface of the photosensitive drum 21 at a developing portion facing the surface of the photosensitive drum 21. The image forming apparatus 1 includes the transfer roller 12 serving as a transfer member configured to transfer the developing agent image to the recording material P serving as the transfer material at a transfer portion facing the surface of the photosensitive drum 21. The image forming apparatus 1 includes the brush power supply 74 and the charging power supply 71. The brush power supply 74 is a brush voltage applying unit serving as a first charging voltage applying unit configured to apply the brush voltage to the charging brush 22. The charging power supply 71 is a charging voltage applying unit serving as a second charging voltage applying unit configured to apply the charging voltage to the charging roller 23. The image forming apparatus 1 includes the control unit 202 configured to control the brush voltage and the charging voltage. The first charging portion Pa is formed downstream of the transfer portion and upstream of the second charging portion Pb in the rotation direction of the photosensitive drum 21. A potential difference formed between a first surface potential formed on the surface of the photosensitive drum 21 and the brush voltage at the first charging portion Pa is defined as the first charging potential difference. A potential difference formed between a second surface potential formed on the surface of the photosensitive drum 21 and the charging voltage at the second charging portion Pb is defined as the second charging potential difference.

The control unit 202 performs control so that the second charging potential difference is greater than or equal to the discharge start voltage during the image forming operation. Then, in a state where the photosensitive drum 21 is rotated and the brush voltage is applied, the control unit 202 performs controls so that the second charging potential difference during a non-image forming operation different from the image forming operation is less than the second charging potential difference during the image forming operation.

Then, the control unit 202 may perform control so that the charging voltage during the non-image forming operation is less in absolute value than the charging voltage during the image forming operation, and may perform control so that the second charging potential difference is less than the discharge start voltage during the non-image forming operation.

Further, the control unit 202 can perform control so that the charging voltage is greater in absolute value than the brush voltage during the non-image forming operation. The control unit 202 performs control to form the first charging potential difference so that an electric field configured to cause the developing agent charged to the normal polarity to move from the charging brush 22 to the surface of the photosensitive drum 21 is formed during the non-image forming operation. The control unit 202 performs control to form the second charging potential difference so that an electric field configured to cause the developing agent charged to the normal polarity to move from the charging roller 23 to the surface of the photosensitive drum 21 is formed during the non-image forming operation. The control unit 202 performs control so that the brush voltage during the non-image forming operation is greater in absolute value than the brush voltage during the image forming operation. The control unit 202 performs control so that the first charging potential difference is greater than the second charging potential difference during the non-image forming operation.

Further, in the present embodiment, the charging brush 22 has a resistance value of 1.0×10² Ω·cm or more and 1.0×10⁸ Ω·cm or less. The surface layer of the photosensitive drum 21 has a volume resistivity of 1.0×10⁹ Ω·cm or more and 1.0×10¹⁴ Ω·cm or less, and the charging brush 22 is configured to inject charge into the surface of the photosensitive drum 21 to perform injection charging.

The foregoing configuration enables suppression of discharge generated between the photosensitive drum 21 and the charging member.

An image forming apparatus according to a second embodiment will be described. Components common to the first embodiment are not described.

### [Charging Configuration]

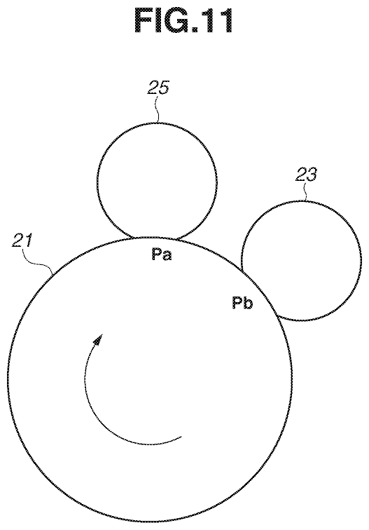

FIG. 11 illustrates a charging configuration according to the second embodiment. In the present embodiment, a charging roller 25 serving as the first charging member is brought into contact with a circumferential position Pa of the photosensitive drum 21 with a predetermined pressing force, and the charging roller 23 serving as the second charging member is brought into contact with a circumferential position Pb of the photosensitive drum 21 with a predetermined pressing force.

A predetermined charging voltage is applied to the charging roller 25, and a predetermined charging voltage is applied to the charging roller 23. The charging rollers 25 and 23 charge the surface of the photosensitive drum 21 using the contact DC charging method.

It may be noted that the charging roller 25 has a structure identical to that of the charging roller 23. A feature of the present embodiment is that the charging roller 25 performs a first discharge and the charging roller 23 performs a second discharge. It may be noted that while the charging roller 25 is configured to have a structure identical to that of the charging roller 23, the structures are not limited to identical structures, and any configuration configured to perform discharge mainly at the first charging portion Pa and the second charging portion Pb may be employed.

### [Voltage Control]

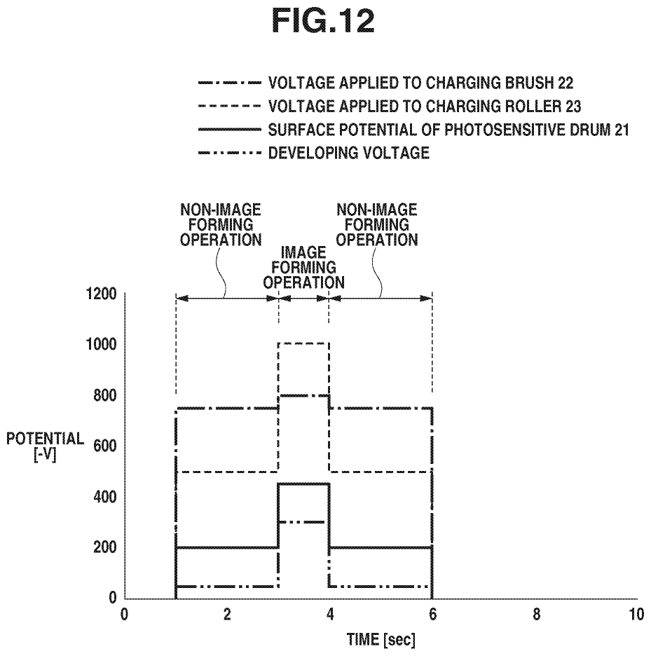

FIG. 12 illustrates a specific example of voltage control in the second embodiment in a case where a single A4-size recording material P is printed. A timing at which an image forming command is input to the image forming apparatus 1 is defined as an origin, and driving of the photosensitive drum 21 is started one second after the origin. Then, for two seconds prior to the start of the image forming operation, a surface potential of the photosensitive drum 21 is formed by voltage control during the non-image forming operation, and the developing voltage is applied to the developing roller 31. Then, once the image forming operation is started, the charging voltages applied to the charging rollers 25 and 23 are changed, and for approximately one second prior to the end of the image forming operation, a surface potential of the photosensitive drum 21 is formed by charging voltage control during the image forming operation, and the developing voltage is controlled to a predetermined value. For two seconds between the end of the image forming operation and the end of driving of the photosensitive drum 21, a surface potential of the photosensitive drum 21 is formed by charging voltage control during the non-image forming operation, and the developing voltage is controlled to a predetermined value. Once driving of the photosensitive drum 21 is stopped, the developing voltage control and the charging voltage control are stopped.

Next, voltage control during the image forming operation in the present embodiment will be described. During the image forming operation, the surface potential of the photosensitive drum 21 is discharged by the pre-exposure device 24, and the surface potential at the first charging portion Pa is approximately 0 V. As illustrated in FIG. 12, a charging voltage of −800 V is applied to the charging roller 25, and the first charging potential difference has a magnitude of −800 V, so that the surface of the photosensitive drum 21 is charged to −250 V by the contact DC charging method in accordance with the characteristic illustrated in FIG. 6. The surface potential of the photosensitive drum 21 at the second charging portion Pb is charged to −250 V, and a charging voltage of −1000 V is applied to the charging roller 23, so that the second charging potential difference has a magnitude of −750 V. At this time, the surface of the photosensitive drum 21 is further charged by −200 V by the contact DC charging method in accordance with the characteristic illustrated in FIG. 6, and ultimately, the surface of the photosensitive drum 21 reaches −450 V. A developing voltage of −300 V is applied to the developing roller 31 herein, and the back contrast is set to −150 V.

Next, voltage control during the non-image forming period in the present embodiment will be described. During the non-image forming operation, the surface potential of the photosensitive drum 21 at the first charging portion Pa is discharged to approximately 0 V by the pre-exposure device 24. As illustrated in FIG. 12, a charging voltage of −750 V is applied to the charging roller 25, and the first charging potential difference has a magnitude of −750 V, so that the surface of the photosensitive drum 21 is charged to −200 V by the contact DC charging method in accordance with the characteristic illustrated in FIG. 6. The surface potential of the photosensitive drum 21 at the second charging portion Pb is −200 V, a charging voltage of −500 V is applied to the charging roller 23, and the second charging potential difference has a magnitude of −300 V. At this time, the surface of the photosensitive drum 21 is not charged by the charging roller 23 in accordance with the characteristic illustrated in FIG. 6, and ultimately, the surface potential of the photosensitive drum 21 reaches −200 V. In other words, the second charging potential difference has a magnitude less than the discharge start voltage Vth, and no discharge occurs, so that no discharge product is generated. Furthermore, the charging voltage is greater in the direction of the polarity of the toner than the surface potential of the photosensitive drum 21, so that fine particles adhering to the charging roller 25 or 23 are not transferred to the photosensitive drum 21. A developing voltage of −50 V is applied to the developing roller 31 herein, and the back contrast is set to −150 V.

By performing the above-described control, the total amount of discharge is reduced so that the total amount of discharge during the non-image forming operation is less than the total amount of discharge during the image forming operation. This makes it possible to suppress discharge generated between a photosensitive drum and a charging member even in a case where charging rollers are employed as the first charging member and the second charging member and a surface of the photosensitive drum is formed by discharge.

As described above, the present disclosure enables suppression of discharge generated between a photosensitive drum and a charging member.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

1. An image forming apparatus configured to perform an image forming operation to form an image on a transfer material, the image forming apparatus comprising:
a photosensitive drum configured to rotate;
a first charging member configured to be brought into contact with a surface of the photosensitive drum to form a first charging portion and charge the surface of the photosensitive drum at the first charging portion in a case where a first charging voltage is applied;
a second charging member configured to charge the surface of the photosensitive drum at a second charging portion facing the surface of the photosensitive drum in a case where a second charging voltage is applied;
an exposure unit configured to form an electrostatic latent image on the surface of the photosensitive drum charged by the first charging member and the second charging member;
a developing member configured to develop the electrostatic latent image with a developing agent to form a developing agent image on the surface of the photosensitive drum at a developing portion facing the surface of the photosensitive drum;
a transfer member configured to transfer the developing agent image to the transfer material at a transfer portion facing the surface of the photosensitive drum;
a first charging voltage applying unit configured to apply the first charging voltage to the first charging member;
a second charging voltage applying unit configured to apply the second charging voltage to the second charging member; and
a control unit configured to control the first charging voltage and the second charging voltage,
wherein the first charging portion is formed downstream of the transfer portion and upstream of the second charging portion in a rotation direction of the photosensitive drum,
wherein a potential difference formed between a first surface potential formed on the surface of the photosensitive drum and the first charging voltage at the first charging portion is defined as a first charging potential difference,
wherein a potential difference formed between a second surface potential formed on the surface of the photosensitive drum and the second charging voltage at the second charging portion is defined as a second charging potential difference, and
wherein the control unit performs
(i) control so that the second charging potential difference is greater than or equal to a discharge start voltage during the image forming operation, and
(ii) control so that, in a state where the photosensitive drum is rotated and the first charging voltage is applied, the second charging potential difference during a non-image forming operation different from the image forming operation is less than the second charging potential difference during the image forming operation.

2. The image forming apparatus according to claim 1, wherein the control unit performs control so that the second charging voltage during the non-image forming operation is less in absolute value than the second charging voltage during the image forming operation.

3. The image forming apparatus according to claim 2, wherein the control unit performs control so that the second charging potential difference is less than the discharge start voltage during the non-image forming operation.

4. The image forming apparatus according to claim 1, wherein the control unit performs control so that the second charging voltage is greater in absolute value than the first charging voltage during the non-image forming operation.

5. The image forming apparatus according to claim 1, wherein the control unit performs control to form the first charging potential difference such that an electric field configured to cause the developing agent charged to a normal polarity to move from the first charging member to the surface of the photosensitive drum is formed during the non-image forming operation.

6. The image forming apparatus according to claim 1, wherein the control unit performs control to form the second charging potential difference such that an electric field configured to cause the developing agent charged to a normal polarity to move from the second charging member to the surface of the photosensitive drum is formed during the non-image forming operation.

7. The image forming apparatus according to claim 1, wherein the control unit performs control so that the first charging voltage during the non-image forming operation is greater in absolute value than the first charging voltage during the image forming operation.

8. The image forming apparatus according to claim 1, wherein the control unit performs control so that the first charging potential difference is greater than the second charging potential difference during the non-image forming operation.

9. An image forming apparatus configured to perform an image forming operation to form an image on a transfer material, the image forming apparatus comprising:
a photosensitive drum configured to rotate;
a first charging member configured to be brought into contact with a surface of the photosensitive drum to form a first charging portion and charge the surface of the photosensitive drum at the first charging portion in a case where a first charging voltage is applied;
a second charging member configured to charge the surface of the photosensitive drum at a second charging portion facing the surface of the photosensitive drum in a case where a second charging voltage is applied;
an exposure unit configured to form an electrostatic latent image on the surface of the photosensitive drum charged by the first charging member and the second charging member;
a developing member configured to develop the electrostatic latent image with a developing agent to form a developing agent image on the surface of the photosensitive drum at a developing portion facing the surface of the photosensitive drum;
a first charging voltage applying unit configured to apply the first charging voltage to the first charging member;
a second charging voltage applying unit configured to apply the second charging voltage to the second charging member; and
a control unit configured to control the first charging voltage and the second charging voltage,
wherein a potential difference formed between a first surface potential formed on the surface of the photosensitive drum and the first charging voltage at the first charging portion is defined as a first charging potential difference,
wherein a potential difference formed between a second surface potential formed on the surface of the photosensitive drum and the second charging voltage at the second charging portion is defined as a second charging potential difference, and
wherein the control unit performs
(i) control so that the second charging potential difference is greater than or equal to a discharge start voltage during the image forming operation, and
(ii) control so that, in a state where the photosensitive drum is rotated, the first charging voltage applied during a non-image forming operation different from the image forming operation is greater in absolute value than the first charging voltage applied during the image forming operation.

10. The image forming apparatus according to claim 9, further comprising a transfer member configured to transfer the developing agent image to the transfer material at a transfer portion facing the surface of the photosensitive drum,
wherein the first charging portion is formed downstream of the transfer portion and upstream of the second charging portion in a rotation direction of the photosensitive drum.

11. The image forming apparatus according to claim 10, wherein the control unit performs control so that the second charging potential difference during the non-image forming operation is less than the second charging potential difference during the image forming operation.

12. The image forming apparatus according to claim 11, wherein the control unit performs control so that the second charging potential difference is less than the discharge start voltage during the non-image forming operation.

13. The image forming apparatus according to claim 9, wherein the control unit performs control so that the second charging voltage is greater in absolute value than the first charging voltage during the non-image forming operation.

14. The image forming apparatus according to claim 9, wherein the control unit performs control to form the first charging potential difference such that an electric field configured to cause the developing agent charged to a normal polarity to move from the first charging member to the surface of the photosensitive drum is formed during the non-image forming operation.

15. The image forming apparatus according to claim 9, wherein the control unit performs control to form the second charging potential difference such that an electric field configured to cause the developing agent charged to a normal polarity to move from the second charging member to the surface of the photosensitive drum is formed during the non-image forming operation.

16. The image forming apparatus according to claim 9, wherein the control unit performs control so that the first charging voltage during the non-image forming operation is greater in absolute value than the first charging voltage during the image forming operation.

17. The image forming apparatus according to claim 9, wherein the control unit performs control so that the first charging potential difference is greater than the second charging potential difference during the non-image forming operation.

18. The image forming apparatus according to claim 1, wherein the first charging member has a resistance value of 1.0×10² Ω·cm or more and 1.0×10⁸ Ω·cm or less.

19. The image forming apparatus according to claim 1, wherein the first charging member has a brush shape.

20. The image forming apparatus according to claim 1, wherein a surface layer of the photosensitive drum has a volume resistivity of 1.0×10⁹ Ω·cm or more and 1.0×10¹⁴ Ω·cm or less.
